(19) United States
(12) Patent Application Publication
(10) Pub. No.: US 2024/0372168 A1
(43) Pub. Date: Nov. 7, 2024

(54) METHOD FOR SECURELY EXTRACTING LITHIUM FROM AN ELECTRICAL BATTERY COMPRISING SOLID METAL LITHIUM

(71) Applicant: BLUE SOLUTIONS, Ergue-Gaberic (FR)

(72) Inventors: Marc DESCHAMPS, Ergue-Gaberic (FR); Vincent BODENEZ, Ergue-Gaberic (FR)

(21) Appl. No.: 18/683,944

(22) PCT Filed: Sep. 5, 2022
(86) PCT No.: PCT/EP2022/074623

§ 371 Date: Feb. 15, 2024

(30) Foreign Application Priority Data
Sep. 9, 2021 (FR) FR2109469

(51) Int. Cl. H01M 10/54; C22B 7/00; C22B 26/12

(52) U.S. Cl. CPC H01M 10/54; C22B 7/004; C22B 7/005; C22B 26/12

(57) ABSTRACT

A method for extracting lithium from a battery including at least two cells, each cell including a negative electrode, a positive electrode and solid or quasi-solid metal lithium; is disclosed. The battery having a first edge from which the negative electrodes of the cells protrude and a second edge which is opposite said first edge and from which the positive electrodes protrude The method including an extraction phase, which includes:
positioning the battery in an orientation in which one of the first and second edges is below the other one of the first and second edges;
heating the battery to a treatment temperature, which is greater than or equal to the melting temperature of the solid metal lithium; and
   cutting the electrical connection between the positive electrodes of at least two of the cells of the battery. The invention further relates to a plant implementing such a method.

The present invention relates to a method for securely extracting lithium from a battery comprising solid lithium metal.

The field of the invention is the field of batteries based on solid lithium metal, and in particular Lithium-Metal-Polymer batteries, and even more particularly the field of recycling these batteries.

### STATE OF THE ART

Batteries based on solid or quasi-solid lithium metal, such as for example Lithium-Metal-Polymer batteries (LMP®), are known. These batteries are being increasingly used, for example in electric vehicles or in power supply stations. Thus, the number of batteries based on solid or quasi-solid lithium metal has been continually rising for several years.

The service life of such batteries is not infinite, and it is essential to recycle them. However, even at the end of its life, such a battery still comprises solid lithium metal, which can be reused in other batteries or in other fields, and is of considerable value.

There are currently very few techniques for recovering solid lithium metal from a battery. These rare techniques provide for heating the battery to a temperature greater than or equal to the melting temperature of the solid lithium metal to recover the lithium in the liquid state. However, these techniques pose a fire risk to the battery.

One purpose of the present invention is to remedy this shortcoming.

Another aim of the invention is to propose a method for efficiently recovering solid or quasi-solid lithium metal from a battery, for all configurations where the cathode and the electrolyte are stable up to at least 181° C. (or up to the melting temperature of the lithium), of electrical energy storage cells by limiting and controlling the effect of short-circuit potentials during the lithium recovery.

### DISCLOSURE OF THE INVENTION

The invention makes it possible to achieve at least one of these aims by a method for extracting lithium from a battery, such as a solid or quasi-solid lithium electrolyte battery, comprising at least two electrical energy storage cells;
each cell comprising a positive electrode, a negative electrode and solid or quasi-solid lithium metal;
said battery comprising a first edge from which the negative electrodes of said cells protrude and a second edge, opposite said first edge, and from which the positive electrodes protrude;
said method comprising an extraction phase comprising the following steps:
   positioning said battery in an orientation in which one of said first and second edges is below the other one of said first and second edges, and
   heating said battery to a temperature, referred to as processing temperature, greater than or equal to the melting temperature of said solid lithium metal;
      characterized in that it further comprises a step of cutting the electrical connection between the positive electrodes of at least two, and in particular all, of the cells of said battery.

Thus, the invention proposes recovering solid lithium metal from a battery by heating said battery to a processing temperature greater than or equal to the melting temperature of the solid lithium metal. Once the lithium metal has melted, all or part of it drains naturally from each cell. Thus, the invention enables a simple and uncomplicated recovery of the solid lithium metal.

Furthermore, the invention proposes a specific orientation of each cell, the latter being, at the very least, inclined. Such an orientation of each cell facilitates the flow of molten lithium out of the cell by gravity.

Furthermore, and above all, the invention provides for cutting the connection between the positive electrodes of at least two, preferentially all, of the battery cells. In other words, the cutting step makes it possible to break the electrical connection between the positive electrodes of the battery cells. Thus, after the cutting step, the battery comprises a plurality of cells that are no longer electrically connected to each other, which reduces the reactivity of the battery, and therefore the risk of the battery catching fire when recovering the lithium.

The first edge can be characterized by the fact that it defines the side via which the lithium, once in the liquid state, must flow.

In the present application, “electrical energy storage cell”, or “cell”, is understood to mean an assembly comprising, at least:
a negative electrode formed by or comprising a solid lithium metal layer;
a positive electrode,
a solid electrolyte, in particular comprising lithium salt, arranged between the positive electrode and the negative electrode, and
a current collector on the positive electrode side.

In the present application, the “solid or quasi-solid lithium metal” can comprise:
pure lithium metal; or
a combination of at least one lithium metal alloy; or
a combination of pure lithium metal and at least one lithium metal alloy.

When the “solid or quasi-solid lithium metal” comprises a combination of different forms of lithium, such as those indicated above, having different melting temperatures, then the heating step heats the battery to a processing temperature greater than or equal to:
the lowest of said different melting temperatures; and
preferentially, the highest of said different melting temperatures.

According to one non-limiting embodiment, the processing temperature is greater than or equal to 180.5° C.

According to one embodiment, the processing temperature is less than or equal to a maximum temperature, for example of 300° C.

The battery may comprise a number of cells greater than or equal to 2.

The battery may comprise several assembled, or in particular stacked, cells along an assembly direction. The assembly direction can be perpendicular to the plane formed by each cell.

In particular, the battery may correspond to a battery in which the cells are connected in series.

According to one embodiment, the cutting step can cut connection wires between the positive electrodes along a cutting line located at, and in particular at the limit of, the second edge, on the side of said electrical connection wires.

This embodiment enables solid lithium metal to be retained in, or not removed from, the battery when the electrical connections are cut, which makes it possible to improve the recovery yield of the lithium.

In this embodiment, the connection wires must be cut sufficiently close to the second edge so that after the cutting, there is no longer any contact between the different positive electrodes.

According to another embodiment, the cutting step can cut the cells along a cutting line located at, and in particular at the limit, of the second edge, on the side of said cells.

In this embodiment, in order to reduce the amount of lithium lost, the cut must be in the immediate vicinity of the second edge.

For example, the cutting can be carried out at a distance “d” from the second edge of less than or equal to 2 mm, or less than or equal to 1% of the size of the cells between the first and the second edges of the battery.

The cutting step can be carried out by guillotining.

In this case, the battery is inserted into a guillotine of suitable size and power.

According to embodiments, the cutting step can be carried out before the start of the heating step.

According to embodiments, the cutting step can be carried out after the start of the heating step. In this case, preferentially, the cutting step can be carried out before solid lithium metal begins to melt.

According to embodiments, the cutting step can be carried out before the positioning step.

According to embodiments, the cutting step can be carried out after the positioning step.

According to embodiments, the cutting step can be carried out during the positioning step.

According to a particularly advantageous feature, the method according to the invention may further comprise, before the extraction phase, a step of electrically charging the battery, said extraction phase being applied to said charged battery.

By electrically charging the battery, and carrying out the extraction phase on the electrically charged cells, it is possible to increase the lithium extraction yield. Indeed, the electrical charging of a cell makes it possible to displace the lithium ions toward the negative electrode, thereby increasing the amount of lithium that can be recovered.

Each cell can be charged individually, or by electrical charging of the battery.

According to a particularly advantageous embodiment, the extraction phase may further comprise a step of compressing the battery.

Thus, the molten lithium is forced to drain out of each cell, thereby increasing the amount of lithium recovered.

The compression step can be carried out continuously throughout the extraction phase. In this case, each cell is subjected to compression, partially or completely, throughout the entire duration of the extraction phase.

Alternatively, the compression step can be carried out on one or more separate occasions during the extraction phase. In this case, the extraction phase comprises moments when the battery is not subjected to compression.

Advantageously, the compression step can apply compression to the surface of the battery by sweeping the surface of said battery from the second edge toward the first edge. Thus, the molten lithium is progressively brought/guided toward the first edge from which the negative electrodes protrude, thereby increasing the amount of lithium recovered and reducing the risk of contact between the lithium and the positive electrodes.

For example, the compression step can be carried out by passing the battery between two rollers.

According to another example, the compression step can be carried out by a compression roller compressing the battery against a bearing surface.

Compression can be applied in successive passes, each pass sweeping the surface of the battery starting from the second edge toward the first edge.

The space between the compression rollers, respectively between the compression roller and the bearing surface, may correspond to the thickness of the battery minus the thickness of the layers of solid lithium metal. This makes it possible to apply compression for as long as there is still solid lithium in the battery.

The space between the two compression rollers, respectively between the compression roller and the bearing surface, can be reduced with each successive pass, so that compression is always being applied to the battery.

The speed at which the battery passes between the compression rollers, respectively of the compression roller, and more generally the sweep speed, may be between a few mm to a few tens of mm, per second.

Furthermore, the method according to the invention may comprise, before the extraction phase, a step of removing at least one electrical connector—also called a “crimp”—from the battery.

This facilitates the processing of the battery.

Furthermore, the method according to the invention may comprise, before the extraction phase, a step of removing any material overhanging at least one, and particularly each, edge of the battery.

According to a first version, the positioning step can position the battery in an orientation in which the first edge of said battery is below the second edge of said battery.

Such an orientation of the battery, and therefore of each battery cell, makes it possible, on the one hand, to facilitate the flow of the molten lithium out of the cell by gravity and, on the other hand, to avoid contact between the molten lithium and the positive electrodes or the current collector of the positive electrode, such contact possibly causing an electrical short-circuit or an electric arc, such a short-circuit possibly causing a fire.

According to a preferred embodiment of this first version, the positioning step can position the battery vertically, with the first edge facing downward.

Thus, the flow of molten lithium out of each cell, by gravity, is improved.

In addition, the risk of contact between the molten lithium and the positive electrode(s) is reduced, or even eliminated.

Preferably, in this first version, the step of heating the battery can be carried out under inert gas.

Thus, the method according to the invention reduces accident risks, in particular fire risks.

In addition, the method according to the invention makes it possible to avoid the formation of pollutants that can be generated by undesired, or even uncontrolled, physicochemical reactions during the lithium extraction.

According to a non-limiting embodiment, the inert gas can be, or comprise, any one of the following gases: helium (He), neon (Ne), argon (Ar), krypton (Kr), xenon (Xe) and radon (Rn).

According to another embodiment of this first version, the step of heating the battery can be carried out under vacuum.

According to a second version, the positioning step can position the battery in an orientation in which the first edge of said battery is above the second edge of said battery. In this case, the extraction phase further comprises, before the heating step, a step of immersing the battery in a liquid, called processing liquid, that is denser than the liquid lithium and electrically insulating.

This second version proposes a specific orientation of each cell, the latter being at least inclined, so that the first edge from which the negative electrodes protrude is above the level of the second edge, opposite the first edge, from which the positive electrodes protrude. Such an orientation of each cell makes it possible, on the one hand, to facilitate the flow of molten lithium out of the cell by a density difference and, on the other hand, to avoid contact between the molten lithium and the positive electrodes or the current collectors of the positive electrodes, such contact possibly causing an electrical short-circuit, such a short-circuit possibly causing a fire. In addition, immersing the set of cell(s) in a liquid makes it possible to improve the dissipation of heat energy from the cell, in particular during a short-circuit, and therefore to greatly limit the effect thereof.

In the present application, “density” refers to the ratio between the density of the liquid under consideration and the density of the water.

According to a preferred embodiment of this second version, the positioning step can position the battery vertically, with the second edge facing downward.

Thus, the flow of molten lithium out of each cell, caused by density difference, is improved.

In addition, the risk of contact between the molten lithium and the positive electrodes is reduced, or even eliminated.

Preferably, the immersion step can be carried out by immersing the battery completely in the processing liquid.

The liquid may be a natural or synthetic oil, comprising the following physicochemical properties:
hydrophobic and non-reactive with respect to lithium,
electrically insulating,
having a density greater than that of lithium,
thermally stable beyond the melting temperature of lithium, that is 180.5° C.,
as high a flash point and self-ignition point as possible.

According to another aspect of the same invention, there is proposed an installation for extracting lithium from a solid or quasi-solid lithium electrolyte battery comprising at least two electrical energy storage cells;
each cell comprising a positive electrode, a negative electrode and solid or quasi-solid lithium metal;
said battery comprising a first edge from which the negative electrodes of said cells protrude and a second edge, opposite said first edge, and from which the positive electrodes protrude;
said installation comprising:
   a means for positioning said battery in an orientation in which one of said first and second edges is below the other one of said first and second edges; and
   a heating means configured to heat said battery to a temperature, referred to as processing temperature, greater than or equal to the melting temperature of said solid lithium metal;
      characterized in that it further comprises a means for cutting the electrical connection between the positive electrodes of at least two, and in particular all, of the cells of said battery.

In general, the installation may comprise means configured to implement any combination of at least one of the features described above, and which are not repeated here in detail for the sake of conciseness.

For example, the cutting means may comprise a guillotine.

In particular, the heating means may comprise an oven.

Advantageously, the oven can be filled with an inert gas, or evacuated, or even filled with a processing liquid denser than the liquid lithium.

The installation according to the invention may further comprise a means for compressing the battery.

The compression means may comprise at least one roller.

In particular, the compression means may comprise a single roller that compresses the battery against a bearing surface. The bearing surface can be heated to accelerate the temperature rise of the battery.

Alternatively, the compression means may comprise two rollers between which the battery is passed.

In general, the compression means can be configured to apply continuous compression, throughout the extraction phase.

Alternatively, the compression means may be configured to apply compression on one or more separate occasions during the extraction phase. In this case, the extraction phase comprises moments when the battery is not subjected to compression.

Advantageously, the compression means can be configured to apply compression, of constant or variable value, gradually or by sweeping over the surface of the battery, from the second edge to the first edge. Thus, the molten lithium is brought/guided gradually toward the first edge located in the low position, which increases the amount of lithium recovered and reduces the risk of contact between the lithium and the positive electrodes.

In the case of the use of one or two compression rollers, compression can be applied to the battery by successive passes. Each pass applies compression by sweeping over the surface of the battery, from the second edge to the first edge. At the end of each pass, the compression can be stopped, by separating the rollers or by separating the roller from the bearing surface, to return to the second edge in order to restart a new pass.

The distance between the rollers, respectively between the compression roller and the bearing surface, can be reduced with each pass, and in particular between two successive passages.

The invention can be implemented to process several batteries, in particular several batteries forming a battery pack and connected together in parallel within said battery pack.

At least two batteries can be aligned side by side, without overlapping, for example in a direction parallel to the first edge.

In this case, compression can be applied to at least two batteries by the same compression means, namely a set of rollers, or a roller interacting with a bearing surface.

### DESCRIPTION OF THE FIGURES AND EMBODIMENTS

Other benefits and features shall become evident upon examining the detailed description of entirely non-limiting embodiments, and from the appended drawings in which:

FIG. 1 is a schematic depiction of a non-limiting exemplary embodiment of a cell within the meaning of the present invention;

FIG. 2 is a schematic depiction of a non-limiting exemplary embodiment of a battery within the meaning of the present invention;

FIG. 3 is a schematic representation of a first non-limiting exemplary embodiment of a method according to the invention;

FIG. 4 is a schematic depiction of a second exemplary embodiment of a method according to the invention;

FIG. 5 is a schematic depiction of a second exemplary embodiment of a method according to the invention;

FIG. 6 is a schematic representation of a first non-limiting exemplary embodiment of an installation according to the invention;

FIG. 7 is a schematic depiction of a second non-limiting exemplary embodiment of an installation according to the invention; and

FIGS. 8a and 8b are schematic representations of examples of cutting the electrical connection between the positive electrodes of the battery cells, which can be implemented in the present invention.

It is clearly understood that the embodiments that will be described hereafter are by no means limiting. In particular, it is possible to imagine variants of the invention that comprise only a selection of the features disclosed hereafter, in isolation from the other features disclosed, if this selection of features is sufficient to confer a technical benefit or to differentiate the invention with respect to the prior art. This selection comprises at least one preferably functional feature that lacks structural details, or only has a portion of the structural details if that portion is only sufficient to confer a technical benefit or to differentiate the invention with respect to the prior state of the art.

In the figures, the same reference has been used for the features that are common to several figures.

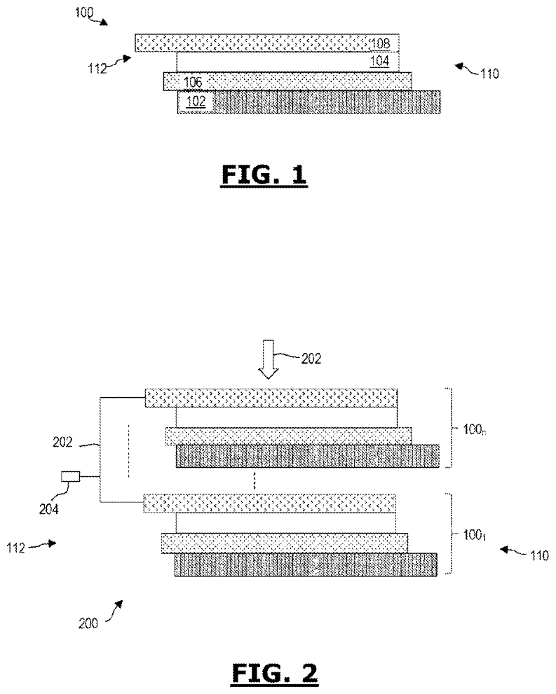

FIG. 1 is a schematic depiction of a non-limiting exemplary embodiment of a cell within the meaning of the present invention.

The cell 100, shown in FIG. 1, comprises a negative electrode 102 formed by, or comprising, a layer of solid lithium metal.

The method 100 further comprises a positive electrode 104.

A solid electrolyte layer 106 is arranged between the negative electrode 102 and the positive electrode 104. This solid electrolyte layer 106 may, for example, comprise lithium salt.

The positive electrode 104 is generally formed by a composite layer of polymer and active material. The cell 100 may further comprise a current collector 108 on the side of the positive electrode 104 and forming part of or associated with the positive electrode 104. The current collector 108 is generally made of aluminum.

Conventionally, the negative electrode 102 of the cell 100 protrudes beyond the other elements of the cell 100 on the side of a first edge 110 of the cell 100, here to the right of the figure. The positive electrode 104 with current collector 108 protrudes beyond the other elements of the cell 100 on the side of a second edge 112, opposite the first edge 110. In the example shown, only the collector 108 protrudes over the second edge 112, here to the left of the figure. In other examples, the overrun could involve just the positive electrode 104 or also the positive electrode 104 and the collector 108.

Of course, the cell 100 shown in FIG. 1 is a very simplified embodiment, given by way of non-limiting illustration. The cell within the meaning of the present invention may comprise other layers than those indicated, or more layers, or layers whose composition is different from the composition given here by way of non-limiting example.

FIG. 2 is a schematic depiction of a non-limiting exemplary embodiment of a battery comprising several cells.

The battery 200, shown in FIG. 2, comprises several identical cells 100₁-100ₙ, assembled in a direction 202 perpendicular to the plane of the layers of each cell 100ᵢ.

Each cell 100ᵢ can be identical to the cell 100 of FIG. 1.

The battery 200 comprises wires/tracks/connection lines 202 connecting the positive electrodes of all the cells 100₁-100ₙ to each other. These connection lines 202 are connected to a connector 204 of the battery 200 forming the positive terminal of the battery 200. This connector 204 is also called a “crimp”.

The battery 200 comprises wires/tracks/connection lines (not shown) for connecting the negative electrodes of all the cells 100₁-100ₙ to each other. These connection lines are connected to a connector (not shown) of the battery 200 forming the negative terminal of the battery 200.

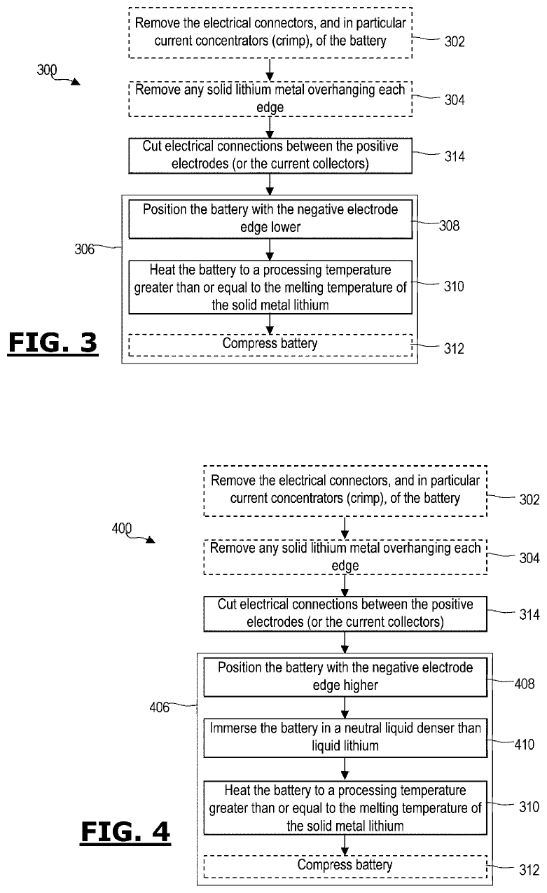

FIG. 3 is a schematic depiction of a non-limiting exemplary embodiment of a method according to the invention.

The method 300, shown in FIG. 3, comprises a first, optional step 302 during which the electrical connectors, and in particular the current concentrators also called “crimps”, of the battery are removed.

During an optional step 304, any overhanging material, and in particular solid lithium metal, at each side edge of the battery is removed.

Next, the method 300 comprises a phase 306 for extracting the lithium metal from the battery cells.

The extraction phase 306 comprises a step 308 of positioning the battery in an orientation in which the first edge from which the negative electrodes protrude is at a lower level than the second edge from which the positive electrodes and/or the collectors protrude. In particular, step 308 positions the battery in a vertical orientation, that is to say parallel to the gravity vector, with the first edge from which the negative electrodes protrude facing downward. Preferably, but in no way limiting, the battery is held in this orientation throughout the extraction phase 306.

The extraction phase 306 further comprises a step 310 of heating the battery to a processing temperature greater than or equal to the melting temperature of the solid lithium metal present in the battery, for example 180.5° C. This temperature will cause the solid lithium metal to melt and be extracted from each cell by flowing naturally under the effect of gravity. Preferably, but in no way limiting, the battery is kept at this temperature throughout the extraction phase 306.

Advantageously, the heating step is carried out in a closed chamber filled with inert gas.

The extraction phase 306 may further comprise an optional step 312 of compressing the battery in order to expel the molten lithium out of each cell of the battery. The compression can be carried out continuously during all, or part, of the extraction phase 306. Alternatively, the compression step 312 can be repeated on several separate occasions during the extraction phase 306. Preferably, the compression step 312 applies compression in a progressive manner, or by sweeping, over the surface of the battery, starting with the second edge from which the positive electrodes protrude and going toward the first edge from which the negative electrodes protrude.

Above all, the method 300 comprises a step 314 of cutting the electrical connection between the positive electrodes/current collectors of at least two, and in particular of all the battery cells. Such a cutting step 314 makes it possible to cut the electrical link between the positive electrodes of the battery cells, thereby reducing the reactivity of the battery. Thus, the risk of the battery catching fire during the extraction phase is reduced, so that the recovery of the solid lithium metal can be carried out more reliably and with less risk.

In the example shown, the step of cutting 314 the electrical connections is carried out before the extraction phase 306. Alternatively, the cutting step 314 can be carried out during the extraction phase 306, before, during or after the positioning step 308, or before, during or after the heating step 310.

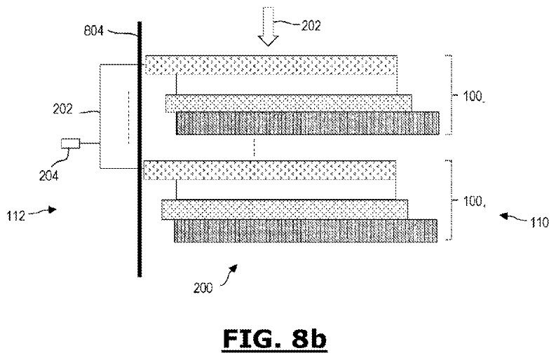

Further non-limiting exemplary embodiments of a step of cutting the electrical connections between the positive electrode of cells, which can be implemented in the present invention, are given with reference to FIGS. 8a and 8b.

FIG. 4 is a schematic depiction of another non-limiting exemplary embodiment of a method according to the invention.

The method 400, shown in FIG. 4, comprises, like the method 300 of FIG. 3, the optional steps of removing 302 the electrical connectors of the battery and of removing 304 the solid lithium metal overhanging each edge of the battery.

The method 400 then comprises the step 314 of cutting the electrical connections between the positive electrodes of the battery cells.

Next, the method 400 comprises a phase 406 of extracting the lithium metal from the cells.

The extraction phase 406 comprises a step 408 of positioning the battery in an orientation in which the first edge 110 from which the negative electrodes 102 protrude is at a higher level, in a vertical direction, than the second edge 112 from which the positive electrodes 104 and the collectors protrude. In particular, step 408 positions the battery in a vertical orientation, that is to say parallel to the gravity vector, with the first edge 110 from which the negative electrodes protrude facing upward. Preferably, but in no way limiting, the battery is held in this orientation throughout the extraction phase 406.

The extraction phase 406 comprises a step 410 of immersing the battery in a neutral processing liquid that is denser than the liquid lithium. For example, the processing liquid may be a natural or synthetic oil, for example a paraffin oil, comprising the following physicochemical properties:
hydrophobic and non-reactive with respect to lithium,
electrically insulating,
a density greater than that of lithium,
thermally stable beyond the lithium melting temperature, that is 180.5° C., and
as high a flash point and a self-ignition point as possible, for example a temperature greater than 600° C., and at least greater than the processing temperature of the cell.

The immersion step 410 is carried out by immersing the battery in the processing liquid so that said processing liquid completely covers the battery.

This immersion step 410 is particularly advantageous as it encourages significant heat exchange between the battery and the processing liquid, which limits the risks of overheating the battery and discharging the heat energy generated in the event of a short-circuit, and improves heating kinetics.

The extraction phase 406 further comprises the heating step 310 described above, and may optionally comprise the compression step 312 described above.

During the heating step, the processing temperature must not exceed a degradation temperature of the processing liquid, beyond which the processing liquid degrades. In other words, the processing liquid, by exceeding a threshold temperature, would change its properties so that the properties stated above are no longer satisfied. Ideally, the degradation temperature of the processing liquid must be greater than +40° C., and for example between +20° C. and +60° C., relative to the melting temperature of the lithium.

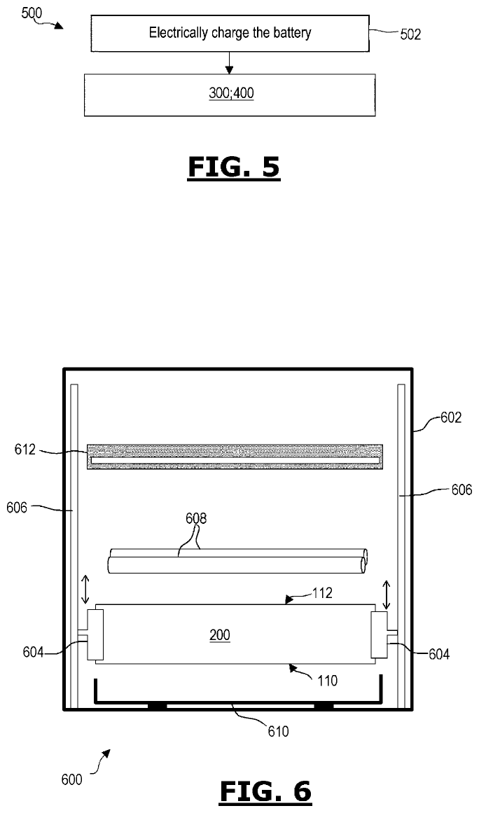

FIG. 5 is a schematic depiction of another non-limiting exemplary embodiment of a method according to the invention.

The method 500, shown in FIG. 5, comprises all the steps of the method 300 of FIG. 3, respectively of the method 400 of FIG. 4.

The method 500 further comprises, prior to the steps of the method 300, respectively of the method 400, a step 502 of electrically recharging at least one cell of the battery.

Said at least one cell can be partially or totally recharged.

Electrically charging a cell makes it possible to increase the amount of lithium available for its extraction because the electrical recharging causes a migration of the lithium ions toward the negative electrode of said cell.

FIG. 6 is a schematic representation of a non-limiting exemplary embodiment of an installation according to the invention.

The installation 600, depicted in FIG. 6, can be used to implement the method according to the invention, and in particular the methods 300 and 500 in FIGS. 3 and 5.

The installation 600 makes it possible to extract and recover part or all of the lithium from the cells of a battery comprising solid lithium metal, such as, for example, the battery 200 of FIG. 2.

The installation 600 comprises an oven 602, filled with an inert gas, or evacuated, configured to heat the battery to a processing temperature, greater than or equal to the melting temperature of the solid lithium metal present in the cells, for example 180.5° C. or 181° C.

The installation 600 comprises a pair of clamps 604 to hold the battery 200 in a vertical, or at least inclined, position, in which the first edge 110 is positioned below the level of the second edge 112. Each clamp 604 is movably mounted on a vertical rail 606 so as to move the battery 200 vertically.

The installation 600 further comprises a pair of rollers 608, having between them a gap corresponding to the thickness of the battery 200 minus the thickness of the solid layers of lithium metal. The pair of rollers 608 is positioned so that, when the clamps 604 are moved upward, the battery 200 passes between the rollers 608, with the second edge 112 first. Thus, the rollers apply compression on the battery 200, progressively starting with the second edge 112 and going toward the first edge 110.

The installation further comprises a receptacle 610 for recovering molten lithium metal that flows out of each cell under the effect of gravity. The receptacle 610 should be inert to lithium.

Advantageously, the installation 600 further comprises a means 612 for cutting the electrical connections between the positive electrodes of the battery.

In the example shown, the cutting means 612 is arranged in the oven 602. Alternatively, the cutting means 612 can be arranged outside the oven 602. For example, the cutting means 612 can be arranged above the oven 602 or on the side of the oven or at a distance from the oven 602.

In the example shown, the cutting means 612 is a guillotine designed to cut the electrical connections. The battery 200 is arranged between the jaws of the guillotine on the side of its second edge, for example by virtue of the clamps 604. The guillotine 612 is then actuated to cut the electrical connections between the positive electrodes of the battery cells.

Alternatively, the cutting means 612 may be shears, a disk grinder, a laser cutting means, and more generally any suitable cutting means.

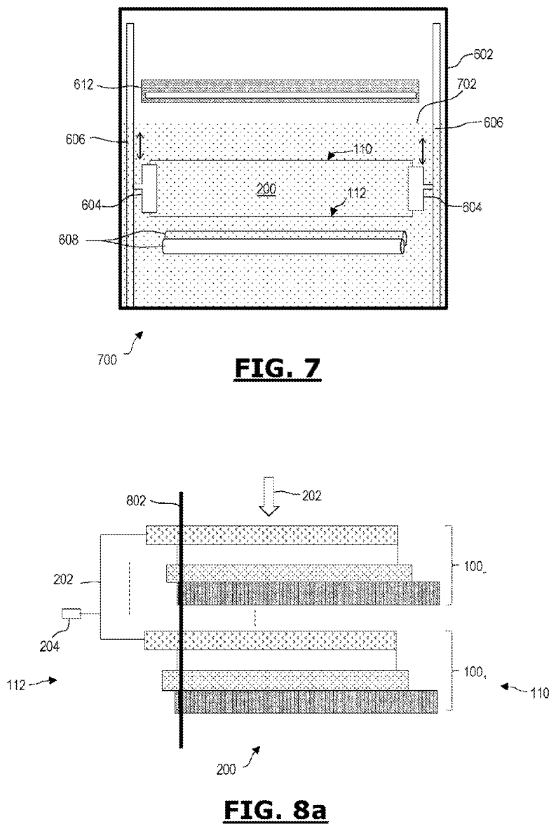

FIG. 7 is a schematic depiction of another non-limiting exemplary embodiment of an installation according to the invention.

The installation 700, depicted in FIG. 7, can be used to implement any method according to the invention, and in particular the methods 400 and 500 in FIGS. 4 and 5.

The installation 700 comprises all the elements of the installation 600 of FIG. 6, except with regards to the differences mentioned below.

In the installation 700, the clamps 604 are configured to orient the battery 200, inclined and preferentially vertically, with the first edge 110 of the battery 200 above the second edge 112.

In addition, the oven 602 does not comprise a recovery receptacle 610.

Furthermore, the pair of rollers 608 is positioned above the battery 200 to apply compression from the second edge 112 of the battery 200 to the first edge 110 of the battery 200

Furthermore, the oven 602 is filled with a processing liquid 702 that completely covers the battery 200. The processing liquid 702 is electrically insulating and inert with respect to the lithium, and especially denser than the molten lithium. This processing liquid 702, denser than lithium, makes it possible to guide the molten lithium toward the first edge 110 so that the molten lithium exits the battery and is located at the surface of the processing liquid 702, and is recovered there.

In the present invention, the cutting of the electrical connections between the positive electrodes of the battery cells can be carried out in different ways.

FIG. 8a gives a first exemplary embodiment of a how the electrical connections between the positive electrodes of the battery can be cut in accordance with the present invention.

In the example shown, the cutting is carried out along a cutting line 802 located at, and in particular at the limit of, the second edge 112, on the side of the cells 100₁-100ₙ of the battery 200. In other words, in this example, the cells forming the battery are cut at the second edge of the battery.

In order to reduce the amount of lithium lost, the cutting may be carried out in the immediate vicinity of the second edge 112. For example, the cutting can be carried out at a distance from the second edge 112 less than or equal to 2 mm, or less than or equal to 1% of the size of the cells between the first edge 110 and the second edge 112 of the battery 200.

FIG. 8b provides another exemplary embodiment of how the electrical connections between the positive electrodes of the battery can be cut in accordance with the present invention.

In the example shown, the cutting is carried out along a cutting line 804 located at, and in particular at the limit of, the second edge 112, on the side of the electrical connection wires 202. In other words, in this example, the cells forming the battery are not cut.

This exemplary embodiment enables solid lithium metal to be retained in, or not removed from, the battery when the electrical connections between the positive electrodes of the cells are cut, which makes it possible to improve the recovery yield of the lithium.

In this exemplary embodiment, the connection wires 202 must be cut sufficiently close to the second edge 112 so that after cutting, there is no longer any contact between the positive electrodes.

Of course, the invention is not limited to the examples detailed above.

For example, the composition of each cell may be different from that indicated in FIG. 1.

In addition, the installation according to the invention may comprise devices other than those shown in FIG. 6 or 7, such as for example means for cutting the electrical connectors of the battery, means for cutting the overhangs on one, or on each, of the edges.

Alternatively to what is described, the clamps 604 can be fixed, and it is the rollers 608, respectively the guillotine 612, which can be movable.

In addition, the invention is not limited to the embodiments described above, but can apply to solid or quasi-solid electrolyte batteries comprising no polymer at the cathode. The invention can be applied to any battery having a solid or quasi-solid electrolyte and a cathode that is stable up to the melting point temperature of the solid or quasi-solid electrolyte component.

1. A method for extracting lithium from a solid or quasi-solid lithium electrolyte battery comprising at least two electrical energy storage cells;
each cell comprising a negative electrode, a positive electrode and solid or quasi-solid lithium metal;
said battery having a first edge from which the negative electrodes of said cells protrude and a second edge, opposite to said first edge, and from which the positive electrodes protrude;
said method comprising an extraction phase comprising the following steps:
positioning said battery in an orientation in which one of said first and second edges is below the other one of said first and second edges;
heating said battery to a temperature, referred to as processing temperature, which is greater than or equal to the melting temperature of said solid lithium metal; and
cutting the electrical connection between the positive electrodes of at least two, and in particular all of the cells of said battery.

2. The method according to claim 1, characterized in that the cutting step cuts connection wires between the positive electrodes along a cutting line located at, and in particular at the limit of, the second edge, on the side of said electrical connection wires.

3. The method according to claim 1, characterized in that the cutting step cuts the cells along a cutting line located at, and in particular at the limit of, the second edge, on the side of said cells.

4. The method according to claim 1, characterized in that the cutting step is carried out by guillotining.

5. The method according to claim 1, characterized in that it further comprises, before the extraction phase, a step of electrically charging the battery, said extraction phase being applied to said charged battery.

6. The method according to claim 1, characterized in that the extraction phase (306; 406) further comprises a step of compressing the battery.

7. The method according to claim 1, characterized in that it comprises, before the extraction phase (306; 406), a step of removing at least one electrical connector from the battery.

8. The method according to claim 1, characterized in that the positioning step positions the battery in an orientation in which the first edge of said battery is below the second edge of said battery.

9. The method according to claim 8, characterized in that the positioning step positions the battery vertically, with the first edge facing downward.

10. The method according to claim 8, characterized in that the step of heating the battery is carried out under inert gas or under vacuum.

11. The method according to claim 1, characterized in that the positioning step positions the battery in an orientation in which the first edge of said battery is located above the second edge of said battery, and in that the extraction phase further comprises, before the heating step, a step of immersing the battery in a liquid, referred to as a processing liquid, that is denser than the liquid lithium and electrically insulating.

12. An installation for extracting lithium from a solid or quasi-solid lithium electrolyte battery, comprising at least two electrical energy storage cells;
each cell comprising a negative electrode, a positive electrode and solid or quasi-solid lithium metal;
said battery having a first edge from which the negative electrodes of said cells protrude and a second edge, opposite to said first edge, and from which the positive electrodes protrude;
said installation comprising:
means for positioning said battery in an orientation in which one of said first and second edges is below the other one of said first and second edges;
heating means configured to heat said battery to a temperature, referred to as processing temperature, greater than or equal to the melting temperature of said solid lithium metal; and
means for cutting the electrical connection between the positive electrodes of at least two, and in particular all, of the cells of said battery.

13. The installation according to claim 12, characterized in that the cutting means comprises a guillotine.

14. The installation according to claim 12, characterized in that the heating means comprises an oven.

15. The installation according to claim 12, characterized in that it comprises a means for compressing the battery.
